(19) United States
(12) Patent Application Publication
(10) Pub. No.: US 2026/0239078 A1
(43) Pub. Date: Aug. 13, 2026

(54) QoS Measurement

(71) Applicant: Telefonaktiebolaget LM Ericsson (publ), Stockholm (SE)

(72) Inventor: Wenliang Xu, Shanghai (CN)

(21) Appl. No.: 19/156,933

(22) PCT Filed: Jul. 14, 2023
(86) PCT No.: PCT/CN2023/107365

§ 371 Date: Aug. 15, 2025

(30) Foreign Application Priority Data
Feb. 17, 2023 (WO) PCT/CN2023/076771
Apr. 11, 2023 (WO) PCT/CN2023/087439

(51) Int. Cl. H04W 24/10

(52) U.S. Cl. CPC H04W 24/10

(57) ABSTRACT

The embodiments herein relate to QoS measurement. In some embodiments, there proposes a method (700) performed by a first network function (212) implementing a Service Enabler Architecture Layer (SEAL) Data Delivery (DD) server. In an embodiment, the method may comprise the step of transmitting (S701), to a Vertical Application Layer (VAL) User Equipment (UE) (201), asubscription message for requesting a reporting of a transmission quality measurement for the VAL UE (201) traffic, wherein the VAL UE (201) includes a first functional component (222) implementing a SEALDD client. In an embodiment, the method may further comprise the step of receiving (S703), from the VAL UE (201), anotification message for providing the reporting of a plurality of measurement results of the transmission quality measurement. The embodiments herein may allow for supporting SEALDD client being configured with data transmission quality measurement requirement and SEALDD client starting data transmission quality measurement procedure.

### CROSS REFERENCE TO RELATED APPLICATIONS

This application claims priorities of PCT Application Serial Number PCT/CN2023/076771 filed on Feb. 17, 2023 with title of “QOS MEASUREMENT FOR MULTIPLE UES” and PCT Application Serial Number PCT/CN2023/087439 filed on Apr. 11, 2023 with title of “QOS MEASUREMENT”, the entire contents of which are incorporated herein by reference.

### TECHNICAL FIELD

The embodiments herein relate generally to the field of communication, and more particularly, the embodiments herein relate to Quality of Service (QoS) measurement.

### BACKGROUND

SEAL (Service Enablement Architecture Layer for Verticals) has been introduced to support vertical applications (e.g. vehicle to everything (V2X) applications) since 3GPP Release 16. 3GPP TS 23.434 specifies application plane and signaling plane entities for application-enabling services (e.g. group management, configuration management, location management, identity/key management, network resource management) that can be reused across vertical applications. SEAL also specifies the northbound Application Programming Interfaces (APIs) for its individual services to enable flexible integration with vertical applications.

FIG. 1 is a schematic block diagram showing generic on-network functional model 100 of SEAL. As shown in FIG. 1, in the Vertical Application Layer (VAL), a VAL client 121 may communicate with a VAL server 111 over VAL-UU reference point. The VAL-UU may support both unicast and multicast delivery modes.

The SEAL functional entities on the User Equipment (UE) 101 and the server are grouped into SEAL client(s) 122 and SEAL server(s) 112 respectively. The SEAL may comprise a common set of services (e.g. group management, location management) and reference points. The SEAL offers its services to the VAL.

The SEAL client(s) 122 may communicate with the SEAL server(s) 112 over the SEAL-UU reference points. The SEAL-UU may support both unicast and multicast delivery modes. The SEAL client(s) 122 may provide the service enabler layer support functions to the VAL client(s) 121 over SEAL-C reference points. The VAL server(s) 111 may communicate with the SEAL server(s) 112 over the SEAL-S reference points. The SEAL server(s) 112 may communicate with the underlying 3GPP network system 102 using the respective 3GPP network interfaces specified by the 3GPP network system 102.

### Data Delivery (DD)

One of the capabilities that SEAL provides is Data Delivery (DD).

FIG. 2 is a schematic block diagram showing the on-network functional model of SEAL for DD, which is architecture 200 for SEAL Data Delivery service.

For uplink (UL) traffic, the VAL client 121 may send VAL application data traffic to a SEALDD client 222 for SEALDD service over SEALDD-C. After data plane packet processing by the SEALDD client 222, the VAL application data traffic may be converted to SEALDD data traffic and transferred to a SEALDD server 212 over SEALDD-UU. The SEALDD server 212 may restore the VAL application data traffic and send it to the VAL server 111 over SEALDD-S. The VAL application traffic data may be included in SEALDD flow data and VAL application traffic may be identified by SEALDD flow id.

For downlink (DL) traffic, the VAL server 111 may send VAL application data traffic to the SEALDD server 212 for SEALDD service over SEALDD-S. After data plane packet processing by the SEALDD server 212, the VAL application data traffic may be converted to SEALDD data traffic and transferred to the SEALDD client 222 over SEALDD-UU. The SEALDD client 222 may restore the VAL application data traffic and send it to the VAL client 121 over SEALDD-C. The VAL application traffic data may be included in SEALDD flow data and VAL application traffic may be identified by SEALDD flow id.

Optionally, VAL deployments may choose to route application signaling traffic and application data traffic for some or all functions it offers using SEALDD service and FIG. 3 illustrates the architecture for achieving this. In this case the VAL client 121 and the VAL server 111 may choose not to maintain application connection by themselves and transfer all the application traffic over SEALDD connections for those functions.

Note that the SEALDD capabilities may be provided as APIs to the VAL layer, it is up to the VAL layer to decide which traffic to be transferred (e.g. application signaling, application data).

FIG. 3 is a schematic block diagram showing example architecture for SEAL application traffic transfer.

The SEALDD client 222 may interact with the SEALDD server 212 to establish application layer data transport path. Through this path, the SEALDD server 212 and the SEALDD client 222 may provide data transport service capabilities such as data plane packet processing (e.g. packet duplication, elimination or transport coordination), data forwarding, data caching, background data transfer, etc. to support the VAL server 111 and the VAL client 121.

The data transport service capabilities provided by the SEALDD client 222 and the SEALDD server 212 may be enhanced by carrying out the data transmission quality measurement. Currently, the SEALDD data transmission quality measurement procedure is not complete, e.g., the SEALDD client does not support receiving the respective measurements configuration and reporting procedure. The SEALDD client does not support receiving corrective action instructed by the SEALDD server, either.

### SUMMARY

The embodiments herein propose methods, network functions, UEs, computer readable medium and computer program product for improving QoS measurement.

In some embodiments, there proposes a method performed by a first network function implementing a SEALDD server. In an embodiment, the method may comprise the step of transmitting, to a VAL UE, a subscription message for requesting a reporting of a transmission quality measurement for the VAL UE traffic. The VAL UE may include a first functional component implementing a SEALDD client. In an embodiment, the method may further comprise the step of receiving, from the VAL UE, a notification message for providing the reporting of a plurality of measurement results of the transmission quality measurement.

In some embodiments, there proposes a method performed by a VAL UE including a first functional component implementing a SEALDD client. In an embodiment, the method may comprise the step of receiving, from a network function implementing a SEALDD server or a second functional component implementing a VAL client within the VAL UE, a subscription message for requesting a reporting of a transmission quality measurement for the VAL UE traffic. In an embodiment, the method may further comprise the step of transmitting a notification message for providing the reporting of a plurality of measurement results of the transmission quality measurement.

In an embodiment, the subscription message may include a first parameter indicating at least one VAL application traffic to be measured. In an embodiment, the subscription message may include a second parameter indicating measurement requirement information. In an embodiment, the subscription message may include a third parameter indicating one or more measurement conditions for the transmission quality measurement.

In an embodiment, the one or more measurement conditions may include one or more spatial conditions and/or one or more temporal conditions. In an embodiment, if the one or more conditions are not satisfied, the first functional component implementing the SEALDD client may stop or suspend the transmission quality measurement.

In an embodiment, the measurement requirement information may include a fourth parameter indicating a measurement on any one or combination of latency, bitrate, or packet loss rate. In an embodiment, the measurement requirement information may include a fifth parameter indicating whether the reporting is set to a periodic reporting. In an embodiment, the measurement requirement information may include a sixth parameter indicating a reporting periodicity if the reporting is set to a periodic reporting. In an embodiment, the measurement requirement information may include a seventh parameter indicating a measurement period window for the transmission quality measurement. In an embodiment, the measurement requirement information may include an eighth parameter indicating a measurement expiration time for the transmission quality measurement. In an embodiment, the measurement requirement information may include a ninth parameter indicating reporting criteria for reporting a measurement result of the transmission quality measurement. In an embodiment, the measurement requirement information may include a tenth parameter indicating a service quality guarantee policy associated with the SEALDD flow.

In an embodiment, the reporting criteria may include reporting the measurement results if the latency or bitrate is higher or lower than a value. In an embodiment, the reporting criteria may include a unique identifier for each criteria of a plurality of criteria predefined.

In an embodiment, the service quality guarantee policy may include an eleventh parameter indicating an event triggering a quality guarantee action. In an embodiment, the service quality guarantee policy may include a twelfth parameter indicating the quality guarantee action to be performed when the event occurs.

In an embodiment, the event may include that a measurement threshold is reached.

In an embodiment, the method may further comprise the step of determining to start measurement process. In an embodiment, the method may further comprise the step of initiating the uplink packet delay measurement. In an embodiment, the method may further comprise the step of obtaining the plurality of measurement results.

In an embodiment, the notification message may include a thirteenth parameter indicating a generated transmission quality measurement reports list for the transmission quality measurement.

In an embodiment, the transmission quality measurement report list may further include a fourteenth parameter indicating a measurement on any one or combination of latency, bitrate, or packet loss rate based on the fourth parameter. In an embodiment, the transmission quality measurement report list may further include a fifteenth parameter indicating an average measurement value of the plurality of measurement results. In an embodiment, the transmission quality measurement report list may further include a sixteenth parameter indicating a minimum measurement value of the plurality of measurement results. In an embodiment, the transmission quality measurement report list may further include a seventeenth parameter indicating a maximum measurement value of the plurality of measurement results. In an embodiment, the transmission quality measurement report list may further include an eighteenth parameter indicating a standard deviation measurement value of the plurality of measurement results. In an embodiment, the transmission quality measurement report list may further include a nineteenth parameter indicating a kpercentile measurement value of the plurality of measurement results. In an embodiment, the transmission quality measurement report list may further include a twentieth parameter indicating a measurement period for the plurality of measurement results based on the seventh parameter. In an embodiment, the transmission quality measurement report list may further include a twenty-first parameter indicating a timestamp of the plurality of measurement results.

In an embodiment, the method may comprise the step of transmitting a response message for responding the subscription message.

In an embodiment, the response message may include a twenty-second parameter indicating whether the subscription is success or failed. In an embodiment, the response message may include a twenty-third parameter indicating an expiration time of the subscription, if the twenty-second parameter indicates that the subscription is success.

In an embodiment, the subscription message may be a transmission quality measurement subscription request. In an embodiment, the notification message may be a transmission quality measurement notification transmitted to the network function implementing the SEALDD server or the second functional component implementing the VAL client. In an embodiment, the response message may be a transmission quality measurement subscription response transmitted to the network function implementing the SEALDD server or the second functional component implementing the VAL client.

In some embodiments, there proposes a method performed by a VAL UE including a first functional component implementing a SEALDD client and a second functional component implementing a VAL client. In an embodiment, the method may comprise the step of transmitting, from the second functional component to the first functional component, a subscription message for requesting a reporting of a transmission quality measurement for the VAL UE traffic. In an embodiment, the method may further comprise the step of transmitting, from the first functional component to the second functional component, a notification message for providing the reporting of a plurality of measurement results of the transmission quality measurement.

In an embodiment, the method may further comprise the step of determining to start measurement process. In an embodiment, the method may further comprise the step of initiating the uplink packet delay measurement. In an embodiment, the method may further comprise the step of obtaining the plurality of measurement results.

In some embodiments, there proposes a method performed by a first network function implementing a SEALDD server. In an embodiment, the method may comprise the step of starting a data transmission quality measurement process of a transmission path. In an embodiment, the method may further comprise the step of transmitting, to a VAL UE, a first request message for requesting a transmission quality guarantee action, based on the measured data transmission quality. The VAL UE may include a first functional component implementing a SEALDD client.

In an embodiment, the first request message may include a twenty-fourth parameter indicating at least one VAL application traffic measured. In an embodiment, the first request message may include a twenty-fifth parameter indicating the transmission quality guarantee action.

In an embodiment, the transmission quality guarantee action may further include establishing a redundant transmission path. In an embodiment, the transmission quality guarantee action may further include reestablishing the transmission path. In an embodiment, the transmission quality guarantee action may further include switching to backup transmission path.

In an embodiment, the first request message may be an Application Triggering message. In an embodiment, the twenty-fifth parameter may indicate a trigger of a redundant connection setup, a connection reestablishment, or a connection switch for a SEALDD packet transmission.

In an embodiment, the method may further comprise the step of receiving, from the VAL UE, a transmission quality guarantee response message. In an embodiment, the transmission quality guarantee response message may include a twenty-sixth parameter indicating whether the request is success or failed.

In an embodiment, the method may further comprise the step of transmitting, to the VAL UE, a second request message for requesting to use a single transmission path.

In an embodiment, the transmission path may be between a second functional component implementing a VAL client of the UE and a second network function implementing a VAL server via the first functional component implementing the SEALDD client and the first network function implementing the SEALDD server.

In some embodiments, there proposes a network function, comprising: at least one processor; and a non-transitory computer readable medium coupled to the at least one processor. In an embodiment, the non-transitory computer readable medium may store instructions executable by the at least one processor, whereby the at least one processor may be configured to perform the above methods related to the above network functions. In an embodiment, the network function may be configured as the above first network function or the second network function.

In some embodiments, there proposes a UE, comprising: at least one processor; and a non-transitory computer readable medium coupled to the at least one processor. In an embodiment, the non-transitory computer readable medium may store instructions executable by the at least one processor, whereby the at least one processor may be configured to perform the above methods related to the above UE or its functional component.

The embodiments herein may allow for supporting SEALDD client being configured with data transmission quality measurement requirement and how SEALDD client starting data transmission quality measurement procedure. The embodiments herein may further allow for supporting SEALDD server instructing SEALDD client about how to mitigate the data transmission quality issue.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 is a schematic block diagram showing generic on-network functional model of SEAL;

FIG. 2 is a schematic block diagram showing the on-network functional model of SEAL for DD;

FIG. 3 is a schematic block diagram showing example architecture for SEAL application traffic transfer;

FIG. 4 is a schematic signaling chart showing the messages in an example SEALDD enabled data transmission quality measurement procedure according to the embodiments herein;

FIG. 5A is a schematic signaling chart showing the messages in another example SEALDD enabled data transmission quality measurement procedure according to the embodiments herein;

FIG. 5B is a schematic signaling chart showing the messages in yet another example SEALDD enabled data transmission quality measurement procedure according to the embodiments herein;

FIG. 6A is a schematic signaling chart showing the messages in an example SEALDD enabled data transmission quality guarantee procedure according to the embodiments herein;

FIG. 6B is a schematic signaling chart showing the messages in another example SEALDD enabled data transmission quality guarantee procedure according to the embodiments herein;

FIG. 7 is a schematic flow chart showing an example method in the first network function, according to the embodiments herein;

FIG. 8 is a schematic flow chart showing an example method in the UE, according to the embodiments herein;

FIG. 9 is a schematic flow chart showing another example method in the UE, according to the embodiments herein;

FIG. 10 is a schematic flow chart showing another example method in the first network function, according to the embodiments herein;

FIG. 11 is a schematic flow chart showing yet another example method in the UE, according to the embodiments herein;

FIG. 12 is a schematic block diagram showing an example first network function, according to the embodiments herein;

FIG. 13 is a schematic block diagram showing an example UE, according to the embodiments herein;

FIG. 14 is a schematic block diagram showing an example computer-implemented apparatus, according to the embodiments herein;

FIG. 15 is a schematic signaling chart showing the messages in SEALDD enabled data transmission quality measurement procedure, according to the embodiments herein; and

FIG. 16 is a schematic signaling chart showing the messages in SEALDD enabled data transmission quality guarantee procedure, according to the embodiments herein.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in an embodiment” appearing in various places throughout the specification are not necessarily all referring to the same embodiment.

The term “A, B, or C” used herein means “A” or “B” or “C”; the term “A, B, and C” used herein means “A” and “B” and “C”; the term “A, B, and/or C” used herein means “A”, “B”, “C”, “A and B”, “A and C”, “B and C” or “A, B, and C”.

Currently, the SEALDD data transmission quality measurement procedure is not complete, e.g., the SEALDD client does not support receiving the respective measurements configuration and reporting procedure. The SEALDD client does not support receiving corrective action instructed by the SEALDD server, either.

In view of the above deficiency, the embodiments propose a solution to improve the QoS measurement in SEALDD layer to support SEALDD client started data transmission quality measurement. In addition, the case of SEALDD server started data transmission quality measurement is also enhanced to mitigate the data transmission quality issue.

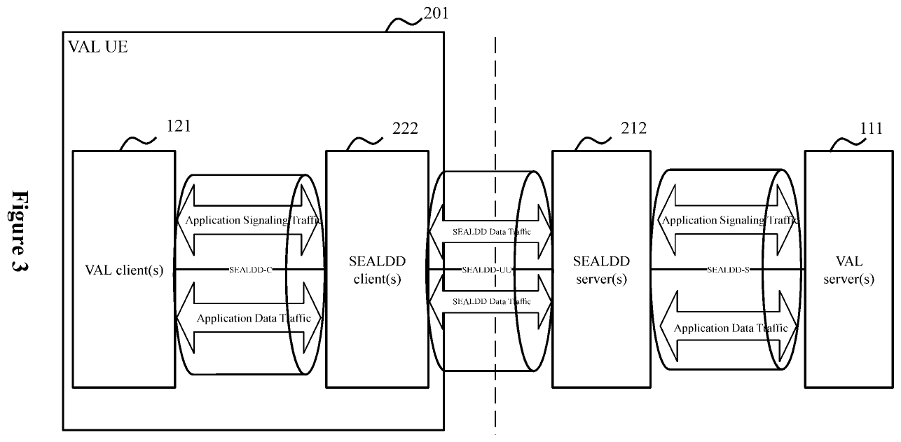

The embodiments may be implemented in the architecture for SEAL Data Delivery service as shown in FIGS. 2 and 3.

In an embodiment, the architecture 200 may be configured in an OTT scenario. The OTT connection may be transparent in the sense that the participating communication devices through which the OTT connection passes are unaware of routing of uplink and downlink communications. For example, a base station may not or need not be informed about the past routing of an incoming downlink communication with data originating from the VAL server(s) 111 or the SEALDD server(s) 212 to be forwarded (e.g., handed over) to a connected UE 201. Similarly, the base station needs not be aware of the future routing of an outgoing uplink communication originating from the UE 201 towards the VAL server(s) 111 or the SEALDD server(s) 212.

It should also be understood that, a network function can be implemented either as a network element on a dedicated hardware, as a software instance running on a dedicated hardware, or as a virtualized function instantiated on an appropriate platform, e.g., on a cloud infrastructure.

As used herein, a UE 101 or 201 refers to a device capable, configured, arranged and/or operable to communicate wirelessly with network nodes and/or other UEs. Examples of a UE 101 or 201 include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE 101 or 201 may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE 101 or 201 may not necessarily have a user in the sense of a human user who owns and/or operates the relevant device. Instead, a UE 101 or 201 may represent a device that is intended for sale to, or operation by, a human user but which may not, or which may not initially, be associated with a specific human user (e.g., a smart sprinkler controller). Alternatively, a UE 101 or 201 may represent a device that is not intended for sale to, or operation by, an end user but which may be associated with or operated for the benefit of a user (e.g., a smart power meter).

Note that, although 3GPP network system 102 is used herein as an example, the embodiments herein may be also applicable to non-3GPP network(s). In that sense, the network system 102 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

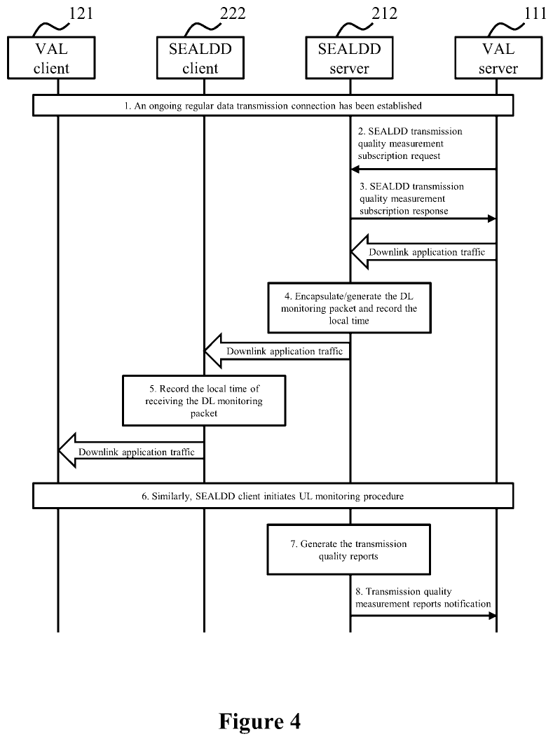

FIG. 4 is a schematic signaling chart showing the messages in an example SEALDD enabled data transmission quality measurement procedure according to the embodiments herein. The SEALDD client 222 and SEALDD server 212 may be enhanced by carrying out the data transmission quality measurement.

Before performing the data transmission quality measurement procedure, the SEALDD server 212 and the SEALDD client 222 may be synchronized to the time source provided by 5GS as specified in 3GPP TS 23.501, and the VAL server 111 may discover and select the SEALDD server 212 by Common API Framework (CAPIF) functions.

In an embodiment, the signaling chart in FIG. 4 may include the following messages or steps:

Step 1. The on-going regular data transmission connection may be established according to clause 9.2.2.2 of 3GPP TS 23.433.

Step 2. The VAL server 111 may send a SEALDD transmission quality measurement subscription request to the SEALDD server 212. The request may include the identifiers of the application traffic (e.g. VAL service ID, VAL server ID), requirement of transmission quality measurement (e.g. latency, bitrate, packet loss rate) and measurement target UE (a single UE, a group of UEs or all UEs), and may also include reporting frequency, spatial condition and temporal condition.

In an example, a group of VAL UE or a VAL UE group may include a plurality of VAL UEs 201 sharing the same VAL service and/or being located in the same geographic area.

The following table 1 describes information flow from the VAL server 111 to the SEALDD server 212 for subscribing the data transmission measurement service.

TABLE 1
SEALDD transmission quality measurement subscription request

| Information element | Status | Description |
|---|---|---|
| Application traffic identifiers | M | Identify of the application traffic (e.g. VAL server |
| | | ID, VAL service ID) |
| VAL UE identity | O | Identifier of specific VAL UE need to be measured, |
| | (See NOTE) | e.g. UE ID, UE address |
| VAL UE group ID | O | Identifier of a specific VAL UE group. |
| | (See NOTE) | |
| All VAL UEs Indication | O | Indicates all VAL UEs of the application identified |
| | (See NOTE) | by application traffic identifiers. |
| Measurement conditions | O | Indicates the temporal and/or spatial conditions. |
| Transmission quality | M | The measurement requirement information |
| measurement requirements list | | |
| > Measurement ID | M | Measurement identifiers, e.g. latency, bitrate, |
| | | packet loss rate |
| > Reporting frequency | O | The reporting frequency of measurement results |
| | | (e.g. periodic reporting). If not present, it implies |
| | | periodic reporting. |
| > Reporting periodicity | O | If the reporting frequency is periodic, the reporting |
| | | periodicity shall be provided. For multiple UEs, it is |
| | | recommended to give sufficient time to allow report |
| | | aggregation. |
| > Reporting granularity | O | The reporting granularity indicates whether the |
| | | measurement report is for individual VAL UE or for |
| | | VAL UE group or for all VAL UEs, if VAL UE group |
| | | or all VAL UEs is the measurement target. |
| > Measurement period window | O | Indicates the measurement period window |
| > measurement expiration time | O | Indicates the measurement expiration time |

NOTE:
One of them shall be present as the measurement target UE.

As shown in table 1, an information element “VAL UE group ID”, which is a group identifier (ID) of the group of VAL UEs, or an information element “All VAL UEs Indication”, which is an indication to indicate the all VAL UEs, may be provided in the subscription request to requesting a reporting of a transmission quality measurement for one or more VAL UEs.

In addition, an information element “Reporting frequency” may be provided in the subscription request to indicate whether the reporting shall be a periodic reporting. If the reporting is set to a periodic reporting, an information element “Reporting periodicity” may be provided in the subscription request to indicate the reporting periodicity.

In addition, an information element “Reporting granularity” may be provided in the subscription request to indicate whether the reporting shall be provided per UE or an aggregation for multiple UEs. The reporting granularity may indicate whether the requested reporting is for a specific VAL UE, an individual VAL UE of multiple VAL UEs, the group of VAL UE, or the all VAL UEs.

In addition, an information element “Measurement conditions” may be provided in the subscription request to indicate one or more spatial conditions and/or one or more temporal conditions for the measurement. If the one or more conditions are not satisfied, the SEALDD server 212 may stop or suspend the transmission quality measurement.

In an example, the VAL server 111 may send a measurement request to the SEALDD server 212 with geographical areas or scheduled route (spatial conditions), and/or start-stop time (temporal conditions) with optional time periodicity.

For an example, the measurement is expected to be done for the VAL UE(s) 201 located in a park or campus, from 9:00 am to 6:00 pm every day.

For another example, the measurement is expected to be done for VAL UE(s) 201 (e.g. a group of V2X UE) with scheduled route (from city A to city B via highway A2 and A3), from 9:00 am to 11:am on Tuesday and from 1:pm to 5:00 pm on Thursday, until 2025 September.

Step 3. Upon receiving the request, the SEALDD server 212 may perform an authorization check. If the authorization check is successful, the SEALDD server 212 may send a response to the VAL server 111 with the subscription ID, an expiration time.

The following table 2 describes the information flow from the SEALDD server 212 to the VAL server 111 for responding to the transmission quality measurement subscription request.

TABLE 2
SEALDD transmission quality measurement subscription
response

| Information | | |
|---|---|---|
| element | Status | Description |
| Result | M | Success or failure. |
| Subscription | M | Subscription identifier |
| ID | | corresponding to the subscription. |
| Expiration | O | Indicates the expiration time of |
| time | | the subscription. |
| | | Applicable for successful result. |

Step 4. The SEALDD server 212 may initiate the Downlink (DL) packet delay measurement based on the request from the VAL server 111 in step 2. The SEALDD server 212 may encapsulate the DL monitoring packet (i.e. DL SEALDD packet with SEALDD DL monitoring header and VAL traffic as payload, or dummy DL SEALDD packet generated for data transmission quality monitoring) with local time T1 when the SEALDD server 212 sends out the DL monitoring packets. The SEALDD server 212 may consider the spatial and/or temporal conditions when starting/resuming the transmission quality measurement. If the conditions are not satisfied, the SEALDD server 212 may stop/suspend the transmission quality measurement.

Step 5. The SEALDD client 222 may receive the DL monitoring packet, and record the local time T2. Note that dummy packet is not sent to VAL client 222.

Step 6. Similarly, the SEALDD client 222 may encapsulate the uplink (UL) monitoring packet (i.e. UL SEALDD packet with SEALDD UL monitoring header and VAL traffic as payload, or dummy UL SEALDD packet generated for data transmission quality monitoring) with local time T2 when the SEALDD client 222 receives the DL monitoring packet and local time T3 when the SEALDD client 222 sends out the UL monitoring packet.

Step 7. The SEALDD server 212 may record the local time T4 when the SEALDD server 212 receives the UL monitoring packet and calculates the packet delay with T1, T2, T3, T4. The SEALDD server 212 may also calculate the bitrate and packet loss rate over a certain period over a specific SEALDD connection by recording the status of the SEALDD packets carrying VAL traffic or dummy SEALDD packets generated for transmission quality measurement reports.

Step 8. The SEALDD server 212 may report the data transmission quality measurement results (e.g. packet delay, bitrate, packet error rate) to the VAL server 111 via the notification message.

When a group of VAL UEs or all VAL UEs indication is received in step 2, the step 4 to step 7 may be repeated for the VAL UEs in the group or for all VAL UEs. The SEALDD server 212 may identify SEALDD connections corresponding to the desired VAL UE(s) 201 to trigger measurement; and depending on the reporting requirement for multiple VAL UEs 201, the SEALDD server 212 may calculate the needed report for the VAL server 111. For example, the SEALDD server 212 may aggregate the one or more transmission quality measurement results, to form an aggregated transmission quality measurement result (such as an average measurement value, a minimum measurement value, and/or a maximum measurement value).

The following table 3 describes the information flow from the SEALDD server 212 to the VAL server 111 for notifying the transmission quality measurement reports.

TABLE 3
SEALDD transmission quality measurement notification

| Information element | Status | Description |
|---|---|---|
| Subscription ID | M | Subscription identifier corresponding to the |
| | | subscription. |
| Transmission quality | M | The generated transmission quality results in |
| measurement reports list | | SEALDD server |
| > Measurement ID | M | Measurement identifiers, e.g. latency, bitrate, |
| | | packet loss rate |
| > VAL UE ID(s) | M | It indicates the VAL UE(s) under SEALDD |
| | | measurement. For a single VAL UE or multiple VAL |
| | | UEs with reporting granularity set to individual UE, |
| | | the associated measurement values are for the |
| | | single or individual VAL UE as indicated in this IE. |
| | | For multiple VAL UEs with reporting granularity set |
| | | to VAL UE group or all VAL UEs, the associated |
| | | measurement values are aggregation for all VAL |
| | | UEs or the VAL UE group and this IE includes the |
| | | measured VAL UEs. |
| > Average measurement value | O | The average measurement value of measurement |
| | | results |
| > Minimum measurement value | O | The minimum measurement value of measurement |
| | | results |
| > maximum measurement value | O | The maximum measurement value of |
| | | measurement results |
| > Measurement period | O | Indicates the measurement period |
| > Timestamp | O | Indicates the timestamp of measurement results |

When the measurement target is for a group of UEs or all UEs, the report may be per UE or an aggregation for the group or all UEs (e.g. average measurement, maximum measurement) depending on reporting requirement. As shown in table 3, an information element “VAL UE ID(s)” may be provided in the notification to show whether the transmission quality measurement and/or report is per UE or an aggregation for multiple UEs.

If the information element “Reporting granularity” in the subscription request is set to a specific VAL UE or is set to an individual VAL UE of multiple VAL UEs, the transmission quality measurement for the one or more VAL UEs may be a transmission quality measurement value for the specific VAL UE or the individual VAL UE.

If the information element “Reporting granularity” in the subscription request is set to multiple UEs, the transmission quality measurement for the one or more VAL UEs may be an aggregation of transmission quality measurement values for the group of VAL UEs or the all VAL UEs

In an example, for the vehicles in a fleet, an average measurement value of the transmission quality for the vehicles may be used for the reselection of the SEALDD server 212. As shown in table 3, an information element “Average measurement value” may be provided in the notification to indicate an average measurement value of a plurality of transmission quality measurement values for the group of VAL UEs or the all VAL UEs.

With the data transmission quality measurement procedure in FIG. 4, the embodiments herein may support multiple VAL UEs in SEALDD Data transmission quality measurement subscription and support different format reports (e.g. average value) for multiple VAL UEs. As a result, the QoS measurement in SEALDD layer may be improved to support multiple VAL UEs in one subscription; otherwise, the VAL server needs to transmit many subscription requests (one per UE data flow).

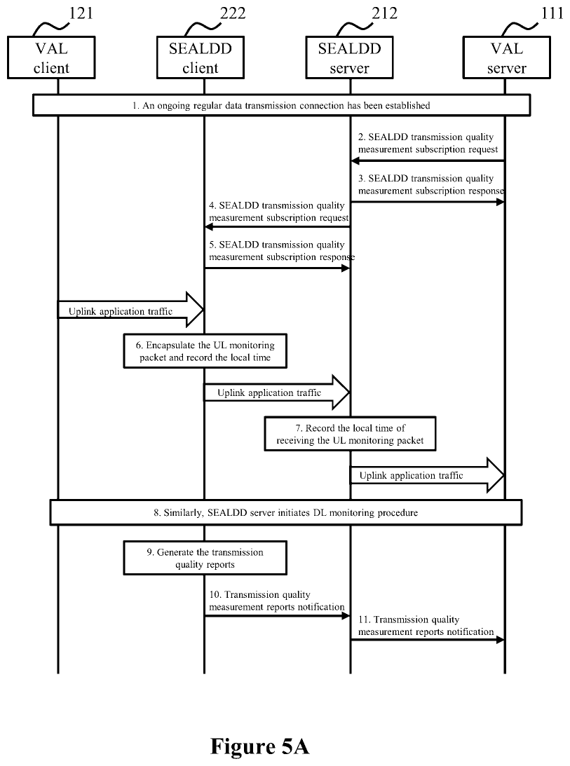

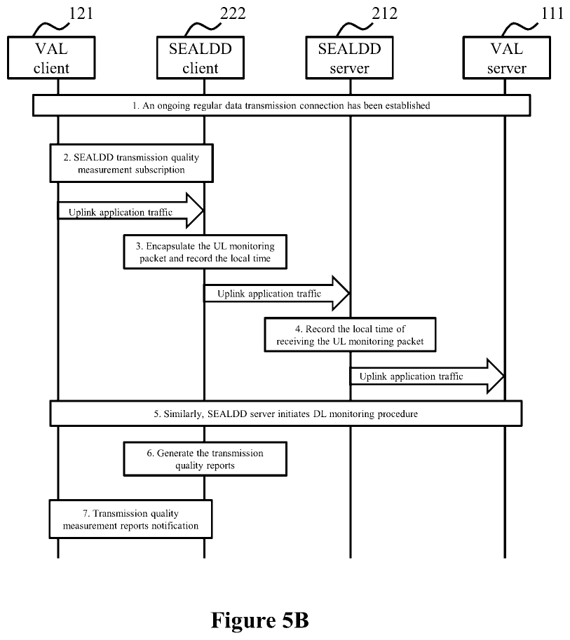

FIG. 5A is a schematic signaling chart showing the messages in another example SEALDD enabled data transmission quality measurement procedure according to the embodiments herein. In an embodiment, FIG. 5A shows the VAL data transmission quality measurement reported by the SEALDD client 222. The SEALDD client 222 may receive transmission quality measurement requirement, decide to start VAL data transmission monitoring, and generate measurement reports.

In an embodiment, the signaling chart in FIG. 5A may include the following messages or steps:

Step 1. An on-going regular data transmission connection is established according to 3GPP TS 23.433 clause 9.2.2.2. In an embodiment, the transmission quality measurement may be triggered by the VAL server 111, which is described in step 2 to step 5.

Step 2. The VAL server 111 may send a SEALDD transmission quality measurement subscription request to the SEALDD server 212. The request includes the identifiers of the application traffic (e.g. VAL service ID, VAL server ID), requirement of transmission quality measurement (e.g. latency, jitter, bitrate) and measurement target UE (e.g. a single UE, a group of UEs or all UEs), and may also include reporting criteria, reporting frequency, spatial condition and temporal condition.

In an embodiment, the spatial and/or temporal condition may be used by the SEALDD client 222 to apply when and where the measurement is performed. For instance, the measurement is expected to be done for a group of VAL UEs with a scheduled route (from city A to city B via highway A2 and A3), from 9:00 a.m. to 11:00 a.m. on Tuesday and from 1:00 p.m. to 5:00 p.m. on Thursday.

Step 3. Upon receiving the request, the SEALDD server 212 may perform an authorization check. If the authorization check is successful, the SEALDD server 212 may respond to the VAL server 111.

Step 4. The SEALDD server 212 may send a SEALDD transmission quality measurement subscription request to the SEALDD client 222.

The following table 4 describes the information flow from the SEALDD server 212 to the SEALDD client 222 for data transmission measurement subscription.

TABLE 4
transmission quality measurement subscription request

| Information element | Status | Description |
|---|---|---|
| SEALDD flow ID | M | Identifier of the SEALDD flow. |
| Measurement conditions | O | Indicates the temporal and/or spatial conditions. |
| Transmission quality measurement | M | The measurement requirement information |
| requirements list | | |
| > Measurement ID | M | Measurement identifiers, e.g. latency, bitrate, jitter |
| > Reporting frequency | O | The reporting frequency of measurement results (e.g. |
| | | periodic reporting). If not present, it implies periodic |
| | | reporting. |
| > Reporting periodicity | O | If the reporting frequency is periodic, the reporting |
| | | periodicity shall be provided. |
| > Measurement period window | O | Indicates the measurement period window for |
| | | transmission quality measurements |
| > Measurement expiration time | O | Indicates the measurement expiration time |
| > Reporting criteria | O | Indicates the criteria for reporting measurement results, |
| | | e.g. if the latency or bitrate reaches below or above a |
| | | certain value. It also includes a unique identifier for |
| | | each criteria of more than one criteria is specified. |
| > Service policy | O | Specifies quality guarantee policies associated with the |
| | | SEALDD connection |
| >> Quality guarantee event | M | Indicates the event (e.g. measurement threshold) that |
| | | triggers performing the quality guarantee action. |
| >> Quality guarantee action | M | Indicates the action to be performed when the |
| | | measurement event occurs, in order to meet the quality |
| | | guarantee. |

In an embodiment, the SEALDD flow ID in the table 4 may be used by the SEALDD client 222 and the SEALDD server 212 to identify different VAL application traffic of the same SEALDD client 222. The SEALDD flow ID may be same with the identifiers of the application traffic or new simplified IDs allocated by the SEALDD. The VAL application traffic data may be included in SEALDD flow data and VAL application traffic may be identified by SEALDD flow ID.

Step 5. The SEALDD client 222 may respond to the SEALDD server.

The following table 5 describes the information flow from the SEALDD client 222 to the SEALDD server 212 for responding to the transmission quality measurement subscription request.

TABLE 5
transmission quality measurement subscription response

| Information element | Status | Description |
|---|---|---|
| Result | M | Success or failure. |
| Expiration time | O | Indicates the expiration |
| | | time of the subscription. |
| | | Applicable for |
| | | successful result. |

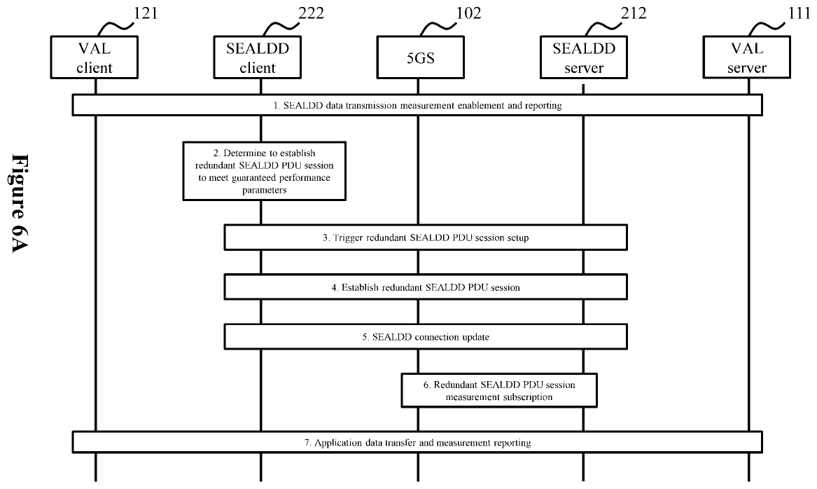

The SEALDD client 222, based on the received service quality guarantee policy including thresholds and action, may take a corrective action as described in the embodiments shown in FIGS. 6A and/or 6B.

Step 6. After the SEALDD client 222 determines to start the measurement process, upon UL packet arrival, the SEALDD client 222 may initiate the UL packet delay measurement.

The SEALDD client 222 may encapsulate the UL monitoring packet (i.e., UL SEALDD packet with SEALDD UL monitoring header and VAL traffic as payload for VAL data transmission quality monitoring) with a local time T1 when the SEALDD client 222 sends out the UL monitoring packet.

The SEALDD client 222 may consider the spatial and/or temporal conditions when starting/resuming the transmission quality measurement. If the conditions are not satisfied, the SEALDD client 222 may stop/suspend the transmission quality measurement.

Step 7. The SEALDD server 212 may receive the UL monitoring packet, and record the local time T2.

Step 8. Similarly, the SEALDD server 212 may encapsulate the DL monitoring packet (i.e., DL SEALDD packet with SEALDD DL monitoring header and VAL traffic as payload, or dummy UL SEALDD packet generated for data transmission quality monitoring in case there is no DL VAL traffic for DL packet delay monitoring) with the local time T2 recorded in step 7 and a local time T3 when the SEALDD server 212 sends out the DL monitoring packet.

In an embodiment, when the SEALDD server 212 sends the dummy UL packet as monitoring response to the SEALDD client 222 may depend on the SEALDD server implementation.

Step 9. The SEALDD client 222 may record a local time T4 when the SEALDD client 222 receives the DL monitoring packet and calculate the latency with T1, T2, T3, T4.

The SEALDD client 222 may also calculate the bitrate and jitter over a certain period over a specific SEALDD connection by recording the status of the SEALDD monitoring packets.

The SEALDD client 222 may also evaluate the reporting criteria (if present) in the SEALDD transmission quality measurement subscription request in order to generate the transmission quality measurement report.

Steps 10-11. The SEALDD client 222 may report the data transmission quality measurement results (e.g. latency, jitter, bitrate) to the VAL server 111 via the SEALDD server 212.

The following table 6 describes the information flow from the SEALDD client 222 to the SEALDD server 212 for notifying the transmission quality measurement reports.

TABLE 6
transmission quality measurement notification

| Information element | Status | Description |
|---|---|---|
| Transmission quality measurement | M | The generated transmission quality results in SEALDD |
| reports list | | server |
| > Measurement ID | M | Measurement identifiers, e.g. latency, bitrate, jitter |
| > Average measurement value | O | The average measurement value of measurement results |
| > Minimum measurement value | O | The minimum measurement value of measurement |
| | | results |
| > maximum measurement value | O | The maximum measurement value of measurement |
| | | results |
| > Standard deviation measurement | O | Standard deviation measurement value of measurement |
| value | | results |
| > kPercentile measurement value | O | Indicates the kpercentile measurement value of |
| | | measurement results |
| > Measurement period | O | Indicates the measurement period |
| > Timestamp | O | Indicates the timestamp of measurement results |

In an embodiment, when a VAL group ID or a list of VAL UE IDs or all VAL UEs indication is received in step 2, the above step 4 to step 10 may be repeated for the VAL UEs in the group/list or for all VAL UEs. The SEALDD server 212 may map the VAL UE group ID to a list of VAL UE IDs if a VAL group ID is received. The SEALDD server 212 may identify SEALDD connections corresponding to the desired VAL UE(s) to trigger measurement; and depending on the reporting requirement for multiple UEs, the SEALDD server 212 may collect and aggregate the needed report for the VAL server 111.

FIG. 5B is a schematic signaling chart showing the messages in yet another example SEALDD enabled data transmission quality measurement procedure according to the embodiments herein. In an embodiment, FIG. 5B shows the VAL data transmission quality measurement reported by the SEALDD client 222. The SEALDD client 222 may receive transmission quality measurement requirement, decide to start VAL data transmission monitoring, and generate measurement reports.

In an embodiment, the signaling chart in FIG. 5B may include the following messages or steps:

Step 1. An on-going regular data transmission connection is established according to 3GPP TS 23.433 clause 9.2.2.2. In an embodiment, the transmission quality measurement may be triggered by the VAL client 121, which is described in step 2.

Step 2. The VAL client 121 may trigger the SEALDD transmission quality measurement procedure to the SEALDD client 222, in order to collect the measurement report information. The VAL client 121 may use messages similar to those in the above steps 4, 5 in FIG. 5A or parameters similar to those in the above tables 4, 5 for triggering the SEALDD transmission quality measurement procedure.

Step 3. After the SEALDD client 222 determines to start the measurement process, upon UL packet arrival, the SEALDD client 222 may initiate the UL packet delay measurement.

The SEALDD client 222 may encapsulate the UL monitoring packet (i.e., UL SEALDD packet with SEALDD UL monitoring header and VAL traffic as payload for VAL data transmission quality monitoring) with a local time T1 when the SEALDD client 222 sends out the UL monitoring packet.

The SEALDD client 222 may consider the spatial and/or temporal conditions when starting/resuming the transmission quality measurement. If the conditions are not satisfied, the SEALDD client 222 may stop/suspend the transmission quality measurement.

Step 4. The SEALDD server 212 may receive the UL monitoring packet, and record the local time T2.

Step 5. Similarly, the SEALDD server 212 may encapsulate the DL monitoring packet (i.e., DL SEALDD packet with SEALDD DL monitoring header and VAL traffic as payload, or dummy UL SEALDD packet generated for data transmission quality monitoring in case there is no DL VAL traffic for DL packet delay monitoring) with the local time T2 recorded in step 4 and a local time T3 when the SEALDD server 212 sends out the DL monitoring packet.

In an embodiment, when the SEALDD server 212 sends the dummy UL packet as monitoring response to the SEALDD client 222 may depend on the SEALDD server implementation.

Step 6. The SEALDD client 222 may record a local time T4 when the SEALDD client 222 receives the DL monitoring packet and calculate the latency with T1, T2, T3, T4.

The SEALDD client 222 may also calculate the bitrate and jitter over a certain period over a specific SEALDD connection by recording the status of the SEALDD monitoring packets.

The SEALDD client 222 may also evaluate the reporting criteria (if present) in the SEALDD transmission quality measurement subscription request in order to generate the transmission quality measurement report.

Step 7. The SEALDD client 222 may report the data transmission quality measurement results to the VAL client 121. The SEALDD client 222 may use the message similar to that in the above step 10 in FIG. 5A or parameters similar to those in the above table 6 for reporting the data transmission quality measurement results.

The embodiments herein may allow for supporting SEALDD client being configured with data transmission quality measurement requirement and SEALDD client starting data transmission quality measurement procedure.

FIG. 6A is a schematic signaling chart showing the messages in an example SEALDD enabled data transmission quality guarantee procedure according to the embodiments herein. In an embodiment, FIG. 6A shows the procedure of using redundant transmission as the action to meet connection reliability requirements specified by a SEALDD service policy.

In an embodiment, a SEALDD service policy, which includes data transmission quality guarantees, may be available to the SEALDD server 212, the SEALDD client 222 and/or the VAL client 121. The policy may be used to configure measurements and determine the necessary SEALDD layer actions for meeting the service policy requirements.

In an embodiment, the SEALDD client 222 may be authorized to request redundant transport services on behalf of the VAL client 121.

In an embodiment, the signaling chart in FIG. 6A may include the following messages or steps:

Step 1. The VAL client 121 and the VAL server 111 may establish a SEALDD connection via the SEALDD client 222 and the SEALDD server 212, to transport the application data.

As part of the connection establishment, the SEALDD service policy is shared so that it is available to both the SEALDD client 222 and the SEALDD server 212. The SEALDD server 212 may use the data transmission quality requirements of this policy in conjunction with other local policies pre-provisioned at the SEALDD server 212. The SEALDD service policy may be locally configured at the SEALDD server 212 or provided by the VAL server 111 and accepted/authorized by the SEALDD server 212.

The SEALDD client 222 may determine whether to start data transmission quality measurement (as shown in FIGS. 5A and 5B). As a result, SEALDD measurements (e.g. packet loss rate, latency) may be configured at the SEALDD client 222 as described in FIGS. 5A and 5B and started accordingly. Then the SEALDD client 222 may receive measurement reports.

Step 2. Based on measurement reports and the SEALDD service policy, the SEALDD client 222 may determine to perform an action so that the data transmission quality requirements of the policy are met.

In an embodiment, the transmission quality guarantee action may include at least one of establishing a redundant transmission path; reestablishing the transmission path; and switching to backup transmission path.

Step 3. The SEALDD client 222 may trigger the establishment of redundant transmission services.

Step 4. The SEALDD client 222 may request using redundant transmission service from the SEALDD server 212. As part of this step, the UE 201 including the VAL client 121 and the SEALDD client 222 may end the initial PDU session and establish redundant PDU sessions.

In an embodiment, the SEALDD client 222 may request at least one of establishing an additional transmission path for redundancy; establishing two new transmission paths and releasing existing transmission path for redundancy; releasing existing transmission path and establishing a new transmission path; and switching to backup transmission path and deactivating existing transmission path.

Step 5. The SEALDD client 222 may update the SEALDD connection with the redundant transmission information, i.e., the UE addresses and ports for the redundant PDU sessions, the SEALDD flow identifier, and the application traffic descriptors. The SEALDD client 222 may also configure the parameters for enabling any necessary SEALDD measurements for the new SEALDD flow.

Step 6. The SEALDD server 212 may subscribe to receive notifications from the 3GPP network system (e.g. 5G network) 102 for user plane measurements (e.g., the network latency requirements specified in 3GPP TS 28.541), network analytics (as specified in 3GPP TS 28.104), etc.

Step 7. The SEALDD client 222 and the SEALDD server 212 may handle data duplication and elimination of application traffic on the redundant SEALDD flows and the necessary measurements may be collected by the SEALDD client 222.

When the SEALDD measurement results indicate that the SEALDD data transmission has good performance according to policy guarantee threshold, if the measurement was started by the SEALDD client 222, the SEALDD client 222 may release one transmission path and return back to single SEALDD connection mode.

FIG. 6B is a schematic signaling chart showing the messages in another example SEALDD enabled data transmission quality guarantee procedure according to the embodiments herein. In an embodiment, FIG. 6B shows the procedure of using redundant transmission as the action to meet connection reliability requirements specified by a SEALDD service policy.

In an embodiment, a SEALDD service policy, which includes data transmission quality guarantees, may be available to the SEALDD server 212, the SEALDD client 222 and/or the VAL client 121. The policy may be used to configure measurements and determine the necessary SEALDD layer actions for meeting the service policy requirements.

In an embodiment, the SEALDD client 222 may be authorized to request redundant transport services on behalf of the VAL client 121.

In an embodiment, the signaling chart in FIG. 6B may include the following messages or steps:

Step 1. The VAL client 121 and the VAL server 111 may establish a SEALDD connection via the SEALDD client 222 and the SEALDD server 212, to transport the application data.

As part of the connection establishment, the SEALDD service policy is shared so that it is available to both the SEALDD client 222 and the SEALDD server 212. The SEALDD server 212 may use the data transmission quality requirements of this policy in conjunction with other local policies pre-provisioned at the SEALDD server 212. The SEALDD service policy may be locally configured at the SEALDD server 212 or provided by the VAL server 111 and accepted/authorized by the SEALDD server 212.

The SEALDD server 212 may determine whether to start data transmission quality measurement (as shown in FIG. 4). As a result, SEALDD measurements (e.g. packet loss rate, latency) may be configured at the SEALDD server 212 as described in FIG. 4 and started accordingly. Then the SEALDD server 212 may receive measurement reports.

Step 2. Based on measurement reports and the SEALDD service policy, the SEALDD server 212 may determine to perform an action so that the data transmission quality requirements of the policy are met.

In an embodiment, the transmission quality guarantee action may include at least one of establishing a redundant transmission path; reestablishing the transmission path; and switching to backup transmission path.

Step 3. The SEALDD server 212 may trigger the establishment of redundant transmission services by sending a transmission quality guarantee request to the SEALDD client 222 for requesting to establish redundant transmission path.

In an embodiment, the request may be sent to the SEALDD client 222 via Application Triggering (specified in clause 4.13.2 of 3GPP TS 23.502) with payload indicating a trigger of a redundant connection setup for SEALDD packet transmission. In another embodiment, the payload may indicate a trigger of connection reestablishment or connection switch.

The following table 7 describes the information flow from the SEALDD server 212 to the SEALDD client 222 for requesting data transmission quality guarantees.

TABLE 7
transmission quality guarantee request

| Information element | Status | Description |
|---|---|---|
| SEALDD flow ID | M | Identifier of the SEALDD flow. |
| Transmission quality | M | Indicates the data transmission |
| guarantee action | | quality guarantee action (e.g. |
| | | redundant transmission path, |
| | | re-establish transmission path). |

The SEALDD client 222 may reply a response to the transmission quality guarantee request to send the result of the request, either success or failed.

The following table 8 describes the information flow from the SEALDD client 222 to the SEALDD server 212 for responding to the transmission quality guarantee request.

TABLE 8
transmission quality guarantee response

| Information | | |
|---|---|---|
| element | Status | Description |
| Result | M | Success or failure. |

Step 4. The SEALDD client 222 may request using redundant transmission service from the SEALDD server 212. As part of this step, the UE 201 including the VAL client 121 and the SEALDD client 222 may end the initial PDU session and establish redundant PDU sessions.

In an embodiment, the SEALDD client 222 may request at least one of establishing an additional transmission path for redundancy; establishing two new transmission paths and releasing existing transmission path for redundancy; releasing existing transmission path and establishing a new transmission path; and switching to backup transmission path and deactivating existing transmission path.

Step 5. The SEALDD client 222 may update the SEALDD connection with the redundant transmission information, i.e., the UE addresses and ports for the redundant PDU sessions, the SEALDD flow identifier, and the application traffic descriptors. The SEALDD server 212 may also configure the parameters for enabling any necessary SEALDD measurements for the new SEALDD flow.

Step 6. The SEALDD server 212 may subscribe to receive notifications from the 3GPP network system (e.g. 5G network) 102 for user plane measurements (e.g., the network latency requirements specified in 3GPP TS 28.541), network analytics (as specified in 3GPP TS 28.104), etc.

Step 7. The SEALDD client 222 and the SEALDD server 212 may handle data duplication and elimination of application traffic on the redundant SEALDD flows, and the necessary measurements may be collected by the SEALDD server 212.

When the SEALDD measurement results indicate that the SEALDD data transmission has good performance according to policy guarantee threshold, the SEALDD server 212 may send a request to the SEALDD client 222 for requesting to use single transmission, then the SEALDD client 222 may release one transmission path and return to single SEALDD connection mode.

The embodiments herein may allow for supporting SEALDD server instructing SEALDD client about how to mitigate the data transmission quality issue.

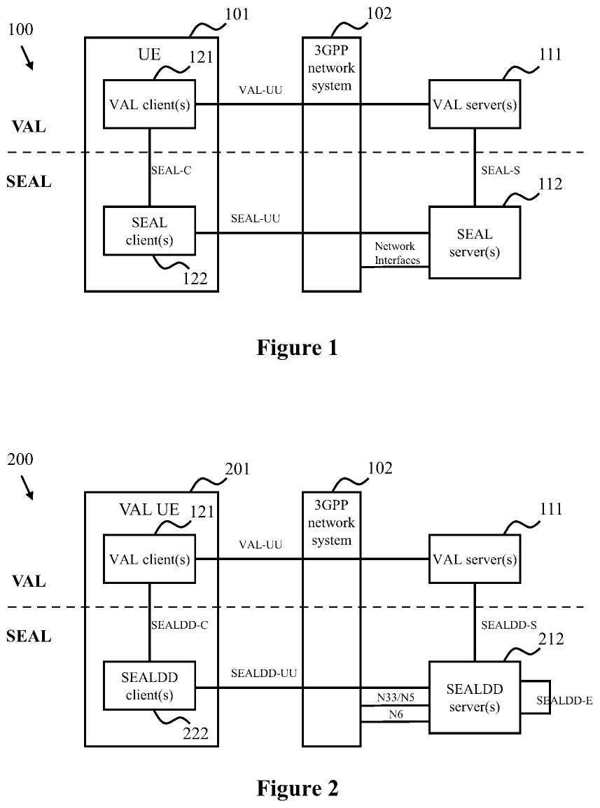

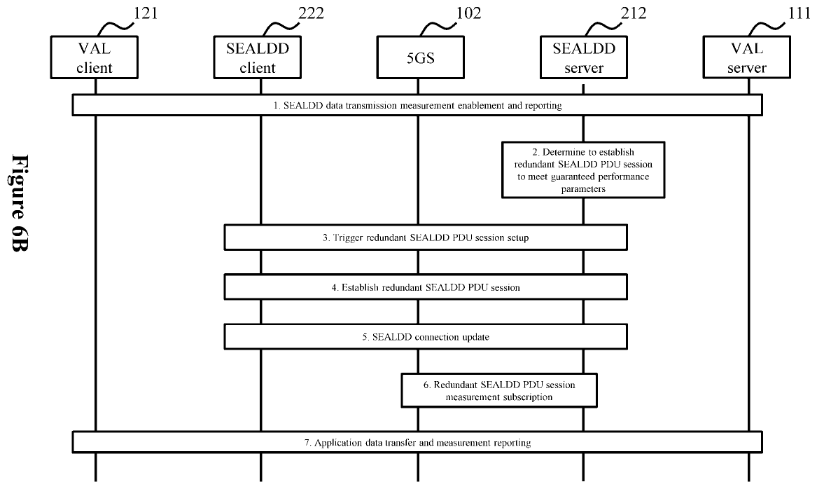

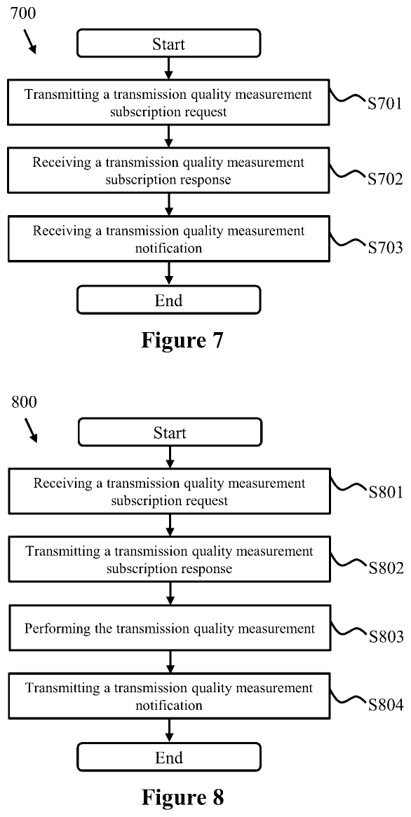

FIG. 7 is a schematic flow chart showing an example method 700 in the first network function, according to the embodiments herein. In an embodiment, the flow chart in FIG. 7 may be implemented in the SEALDD server 212 in FIGS. 1-6B, FIG. 15, and FIG. 16.

The method 700 may begin with step S701, in which the first network function (such as the SEALDD server 212) may transmit, to a VAL UE, a subscription message for requesting a reporting of a transmission quality measurement for the VAL UE traffic. The VAL UE may include a first functional component implementing a SEALDD client. In an embodiment, the subscription message may be a transmission quality measurement subscription request.

In an embodiment, the subscription message may include a first parameter indicating at least one VAL application traffic to be measured. In an embodiment, the subscription message may include a second parameter indicating measurement requirement information. In an embodiment, the subscription message may include a third parameter indicating one or more measurement conditions for the transmission quality measurement.

In an embodiment, the one or more measurement conditions may include one or more spatial conditions and/or one or more temporal conditions. In an embodiment, if the one or more conditions are not satisfied, the first functional component implementing the SEALDD client may stop or suspend the transmission quality measurement.

In an embodiment, the measurement requirement information may include a fourth parameter indicating a measurement on any one or combination of latency, bitrate, or packet loss rate. In an embodiment, the measurement requirement information may include a fifth parameter indicating whether the reporting is set to a periodic reporting. In an embodiment, the measurement requirement information may include a sixth parameter indicating a reporting periodicity if the reporting is set to a periodic reporting. In an embodiment, the measurement requirement information may include a seventh parameter indicating a measurement period window for the transmission quality measurement. In an embodiment, the measurement requirement information may include an eighth parameter indicating a measurement expiration time for the transmission quality measurement. In an embodiment, the measurement requirement information may include a ninth parameter indicating reporting criteria for reporting a measurement result of the transmission quality measurement. In an embodiment, the measurement requirement information may include a tenth parameter indicating a service quality guarantee policy associated with the SEALDD flow.

In an embodiment, the reporting criteria may include reporting the measurement results if the latency or bitrate is higher or lower than a value. In an embodiment, the reporting criteria may include a unique identifier for each criteria of a plurality of criteria predefined.

In an embodiment, the service quality guarantee policy may include an eleventh parameter indicating an event triggering a quality guarantee action. In an embodiment, the service quality guarantee policy may include a twelfth parameter indicating the quality guarantee action to be performed when the event occurs.

In an embodiment, the event may include a measurement threshold is reached.

Then, the method 700 may proceed to step S702, in which the first network function (such as the SEALDD server 212) may receive, from the VAL UE, a response message for responding the subscription message. In an embodiment, the response message may be a transmission quality measurement subscription response.

In an embodiment, the response message may include a twenty-second parameter indicating whether the subscription is success or failed. In an embodiment, the response message may include a twenty-third parameter indicating an expiration time of the subscription, if the twenty-second parameter indicates that the subscription is success.

Then, the method 700 may proceed to step S703, in which the first network function (such as the SEALDD server 212) may receive, from the VAL UE, a notification message for providing the reporting of a plurality of measurement results of the transmission quality measurement. In an embodiment, the notification message may be a transmission quality measurement notification.

In an embodiment, the notification message may include a thirteenth parameter indicating a generated transmission quality measurement reports list for the transmission quality measurement.

In an embodiment, the transmission quality measurement report list may further include a fourteenth parameter indicating a measurement on any one or combination of latency, bitrate, or packet loss rate based on the fourth parameter. In an embodiment, the transmission quality measurement report list may further include a fifteenth parameter indicating an average measurement value of the plurality of measurement results. In an embodiment, the transmission quality measurement report list may further include a sixteenth parameter indicating a minimum measurement value of the plurality of measurement results. In an embodiment, the transmission quality measurement report list may further include a seventeenth parameter indicating a maximum measurement value of the plurality of measurement results. In an embodiment, the transmission quality measurement report list may further include an eighteenth parameter indicating a standard deviation measurement value of the plurality of measurement results. In an embodiment, the transmission quality measurement report list may further include a nineteenth parameter indicating a kpercentile measurement value of the plurality of measurement results. In an embodiment, the transmission quality measurement report list may further include a twentieth parameter indicating a measurement period for the plurality of measurement results based on the seventh parameter. In an embodiment, the transmission quality measurement report list may further include a twenty-first parameter indicating a timestamp of the plurality of measurement results.

The above steps are only examples, and the first network function may perform any related actions described with respect to FIGS. 1-6B, FIG. 15, and FIG. 16.

FIG. 8 is a schematic flow chart showing an example method 800 in the UE, according to the embodiments herein. In an embodiment, the flow chart in FIG. 8 may be implemented in the UE 201 including the SEALDD client 222 in FIGS. 1-6B, FIG. 15, and FIG. 16.

The method 800 may begin with step S801, in which the UE 201 (including the SEALDD client 222) may receive a subscription message for requesting a reporting of a transmission quality measurement for the VAL UE traffic. In an embodiment, the subscription message may be a transmission quality measurement subscription request received from a network function implementing a SEALDD server or a second functional component implementing a VAL client.

In an embodiment, the subscription message may include a first parameter indicating at least one VAL application traffic to be measured.

In an embodiment, the subscription message may include a second parameter indicating measurement requirement information. In an embodiment, the subscription message may include a third parameter indicating one or more measurement conditions for the transmission quality measurement.

In an embodiment, the one or more measurement conditions may include one or more spatial conditions and/or one or more temporal conditions. In an embodiment, if the one or more conditions are not satisfied, the first functional component implementing the SEALDD client may stop or suspend the transmission quality measurement.

In an embodiment, the measurement requirement information may include a fourth parameter indicating a measurement on any one or combination of latency, bitrate, or packet loss rate. In an embodiment, the measurement requirement information may include a fifth parameter indicating whether the reporting is set to a periodic reporting. In an embodiment, the measurement requirement information may include a sixth parameter indicating a reporting periodicity if the reporting is set to a periodic reporting. In an embodiment, the measurement requirement information may include a seventh parameter indicating a measurement period window for the transmission quality measurement. In an embodiment, the measurement requirement information may include an eighth parameter indicating a measurement expiration time for the transmission quality measurement. In an embodiment, the measurement requirement information may include a ninth parameter indicating reporting criteria for reporting a measurement result of the transmission quality measurement. In an embodiment, the measurement requirement information may include a tenth parameter indicating a service quality guarantee policy associated with the SEALDD flow.

In an embodiment, the reporting criteria may include reporting the measurement results if the latency or bitrate is higher or lower than a value. In an embodiment, the reporting criteria may include a unique identifier for each criteria of a plurality of criteria predefined.

In an embodiment, the service quality guarantee policy may include an eleventh parameter indicating an event triggering a quality guarantee action. In an embodiment, the service quality guarantee policy may include a twelfth parameter indicating the quality guarantee action to be performed when the event occurs.

In an embodiment, the event may include a measurement threshold is reached.

Then, the method 800 may proceed to step S802, in which the UE 201 (including the SEALDD client 222) may transmit a response message for responding the subscription message. In an embodiment, the response message may be a transmission quality measurement subscription response transmitted to a network function implementing a SEALDD server or a second functional component implementing a VAL client.

In an embodiment, the response message may include a twenty-second parameter indicating whether the subscription is success or failed. In an embodiment, the response message may include a twenty-third parameter indicating an expiration time of the subscription, if the twenty-second parameter indicates that the subscription is success.

Then, the method 800 may proceed to step S803, in which the UE 201 (including the SEALDD client 222) may perform the transmission quality measurement.

In an embodiment, the UE 201 (including the SEALDD client 222) may determine to start measurement process. In an embodiment, the UE 201 (including the SEALDD client 222) may initiate the uplink packet delay measurement. In an embodiment, the UE 201 (including the SEALDD client 222) may obtain the plurality of measurement results.

Then, the method 800 may proceed to step S804, in which the UE 201 (including the SEALDD client 222) may transmit a notification message for providing the reporting of a plurality of measurement results of the transmission quality measurement.

In an embodiment, the notification message may be a transmission quality measurement notification transmitted to a network function implementing a SEALDD server or a second functional component implementing a VAL client.

In an embodiment, the transmission quality measurement report list may further include a fourteenth parameter indicating a measurement on any one or combination of latency, bitrate, or packet loss rate based on the fourth parameter. In an embodiment, the transmission quality measurement report list may further include a fifteenth parameter indicating an average measurement value of the plurality of measurement results. In an embodiment, the transmission quality measurement report list may further include a sixteenth parameter indicating a minimum measurement value of the plurality of measurement results. In an embodiment, the transmission quality measurement report list may further include a seventeenth parameter indicating a maximum measurement value of the plurality of measurement results. In an embodiment, the transmission quality measurement report list may further include an eighteenth parameter indicating a standard deviation measurement value of the plurality of measurement results. In an embodiment, the transmission quality measurement report list may further include a nineteenth parameter indicating a kpercentile measurement value of the plurality of measurement results. In an embodiment, the transmission quality measurement report list may further include a twentieth parameter indicating a measurement period for the plurality of measurement results based on the seventh parameter. In an embodiment, the transmission quality measurement report list may further include a twenty-first parameter indicating a timestamp of the plurality of measurement results.

The above steps are only examples, and the UE may perform any related actions described with respect to FIGS. 1-6B, FIG. 15, and FIG. 16.

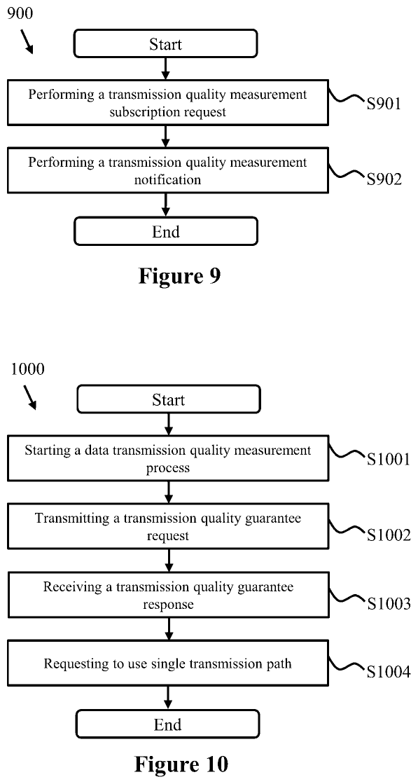

FIG. 9 is a schematic flow chart showing another example method 900 in the UE, according to the embodiments herein. In an embodiment, the flow chart in FIG. 9 may be implemented in the UE 201 including the SEALDD client 222 and the VAL client 121 in FIGS. 1-6B, FIG. 15, and FIG. 16.

The method 900 may begin with step S901, in which the UE 201 (including the SEALDD client 222 and the VAL client 121) may perform a transmission quality measurement subscription request. In an embodiment, the method may comprise the step of transmitting, from the second functional component to the first functional component, a subscription message for requesting a reporting of a transmission quality measurement for the VAL UE traffic. The UE 201 may use the similar messages or parameters similar to those detailed described in FIG. 5A, 5B, 7, 8 for the request.

Then, the method 900 may proceed to step S902, in which the UE 201 (including the SEALDD client 222 and the VAL client 121) may perform a transmission quality measurement notification. In an embodiment, the method may further comprise the step of transmitting, from the first functional component to the second functional component, a notification message for providing the reporting of a plurality of measurement results of the transmission quality measurement. The UE 201 may use the similar messages or parameters similar to those detailed described in FIG. 5A, 5B, 7, 8 for the notification.

The above steps are only examples, and the UE may perform any related actions described with respect to FIGS. 1-6B, FIG. 15, and FIG. 16.

FIG. 10 is a schematic flow chart showing another example method 1000 in the first network function, according to the embodiments herein. In an embodiment, the flow chart in FIG. 10 may be implemented in the SEALDD server 212 in FIGS. 1-6B, FIG. 15, and FIG. 16.

The method 1000 may begin with step S1001, in which the first network function (such as the SEALDD server 212) may start a data transmission quality measurement process of a transmission path. For example, the first network function (such as the SEALDD server 212) may start a data transmission quality measurement process as shown in FIG. 4.

In an embodiment, the transmission path may be between a second functional component implementing a VAL client of the UE and a second network function implementing a VAL server via the first functional component implementing the SEALDD client and the first network function implementing the SEALDD server.

Then, the method 1000 may proceed to step S1002, in which the first network function (such as the SEALDD server 212) may transmit, to a VAL UE, a first request message for requesting a transmission quality guarantee action, based on the measured data transmission quality. The VAL UE may include a first functional component implementing a SEALDD client.

In an embodiment, the first request message may include a twenty-fourth parameter indicating at least one VAL application traffic measured. In an embodiment, the first request message may include a twenty-fifth parameter indicating the transmission quality guarantee action.

In an embodiment, the transmission quality guarantee action may further include establishing a redundant transmission path. In an embodiment, the transmission quality guarantee action may further include reestablishing the transmission path. In an embodiment, the transmission quality guarantee action may further include switching to backup transmission path.

In an embodiment, the first request message may be an Application Triggering message. In an embodiment, the twenty-fifth parameter may indicate a trigger of a redundant connection setup, a connection reestablishment, or a connection switch for a SEALDD packet transmission.

Then, the method 1000 may proceed to step S1003, in which the first network function (such as the SEALDD server 212) may receive, from the VAL UE, a transmission quality guarantee response message. In an embodiment, the transmission quality guarantee response message may include a twenty-sixth parameter indicating whether the request is success or failed.

Then, the method 1000 may proceed to step S1004, in which the first network function (such as the SEALDD server 212) may transmit, to the VAL UE, a second request message for requesting to use a single transmission path.

The above steps are only examples, and the first network function may perform any related actions described with respect to FIGS. 1-6B, FIG. 15, and FIG. 16.

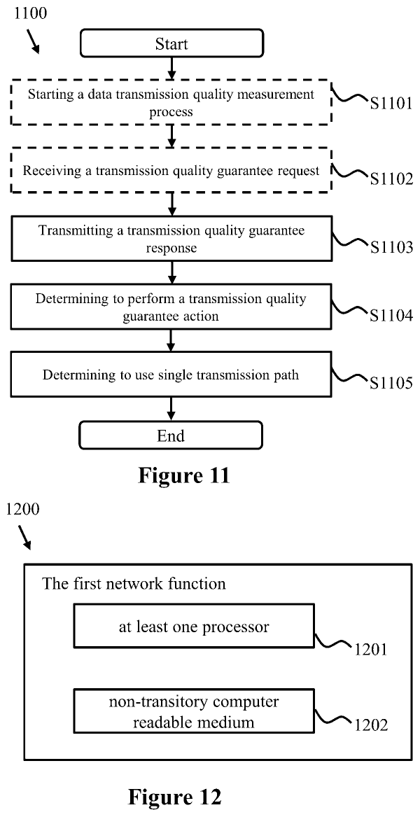

FIG. 11 is a schematic flow chart showing yet another example method 1100 in the UE, according to the embodiments herein. In an embodiment, the flow chart in FIG. 11 may be implemented in the UE 201 including the SEALDD client 222 in FIGS. 1-6B, FIG. 15, and FIG. 16.

The method 1100 may begin with an optional step S1101, in which the UE 201 (including the SEALDD client 222) may receive a first request message for requesting a transmission quality guarantee action from a first network function implementing a SEALDD server.

In an embodiment, the first request message may include a twenty-fourth parameter indicating at least one VAL application traffic measured. In an embodiment, the first request message may include a twenty-fifth parameter indicating the transmission quality guarantee action.

In an embodiment, the first request message may be an Application Triggering message. In an embodiment, the twenty-fifth parameter may indicate a trigger of a redundant connection setup, a connection reestablishment, or a connection switch for a SEALDD packet transmission.

In an embodiment, the transmission path may be between a second functional component implementing a VAL client of the UE and a second network function implementing a VAL server via the first functional component implementing the SEALDD client and the first network function implementing the SEALDD server.

Then, the method 1100 may proceed to an optional step S1102, in which the UE 201 (including the SEALDD client 222) may perform a data transmission quality measurement process of a transmission path. For example, the UE 201 (including the SEALDD client 222) may start a data transmission quality measurement process as shown in FIG. 5A or 5B.

Then, the method 1100 may proceed to step S1103, in which the UE 201 (including the SEALDD client 222) may transmit, to the first network function implementing the SEALDD server, a transmission quality guarantee response message. In an embodiment, the transmission quality guarantee message may include a twenty-sixth parameter indicating whether the first request is success or failed.

Then, the method 1100 may proceed to step S1104, in which the UE 201 (including the SEALDD client 222) may determine to perform a transmission quality guarantee action.

In an embodiment, the transmission quality guarantee action is in response to receiving (as shown in step S1101) a first request message for requesting a transmission quality guarantee action from a first network function implementing a SEALDD server.

In an embodiment, the transmission quality guarantee action is based on a measured data transmission quality of a data transmission quality measurement process (as shown in step S1102) of a transmission path.

In an embodiment, the transmission quality guarantee action may further include establishing a redundant transmission path. In an embodiment, the transmission quality guarantee action may further include reestablishing the transmission path. In an embodiment, the transmission quality guarantee action may further include switching to backup transmission path.

In an embodiment, performing the transmission quality guarantee action may further comprise the step of establishing an additional transmission path for redundancy. In an embodiment, performing the transmission quality guarantee action may further comprise the step of establishing two new transmission paths and releasing existing transmission path for redundancy. In an embodiment, performing the transmission quality guarantee action may further comprise the step of releasing existing transmission path and establishing a new transmission path. In an embodiment, performing the transmission quality guarantee action may further comprise the step of switching to backup transmission path and deactivating existing transmission path.

Then, the method 1100 may proceed to step S1105, in which the UE 201 (including the SEALDD client 222) may determining to use a single transmission path. In an embodiment, determining to use a single transmission path is in response to a second request message from the first network function implementing the SEALDD server for requesting to use a single transmission path. In an embodiment, determining to use a single transmission path is based on a measured data transmission quality of another data transmission quality measurement process of the transmission path.

In an embodiment, the method may further comprise the step of releasing at least one transmission path and returning to single SEALDD connection mode.

The above steps are only examples, and the UE may perform any related actions described with respect to FIGS. 1-6B, FIG. 15, and FIG. 16.

FIG. 12 is a schematic block diagram showing an example first network function 1200, according to the embodiments herein. In an embodiment, the example first network function 1200 in FIG. 12 may be implemented as the SEALDD server 212 in FIGS. 1-6B, FIG. 15, and FIG. 16.

In an embodiment, the first network function 1200 may include at least one processor 1201; and a non-transitory computer readable medium 1202 coupled to the at least one processor 1201. The non-transitory computer readable medium 1202 may store instructions executable by the at least one processor 1201, whereby the at least one processor 1201 is configured to perform the steps in the example methods 700 and 1000 as shown in the schematic flow charts of FIGS. 7 and 10; the details thereof are omitted here.

Note that, the first network function 1200 may be implemented as hardware, software, firmware and any combination thereof. For example, the first network function 1200 may include a plurality of units, circuities, modules or the like, each of which may be used to perform one or more steps of the example methods 700 and 1000 or one or more steps shown in FIGS. 1-6B, FIG. 15, and FIG. 16 related to the first network function (such as the SEALDD server 212).

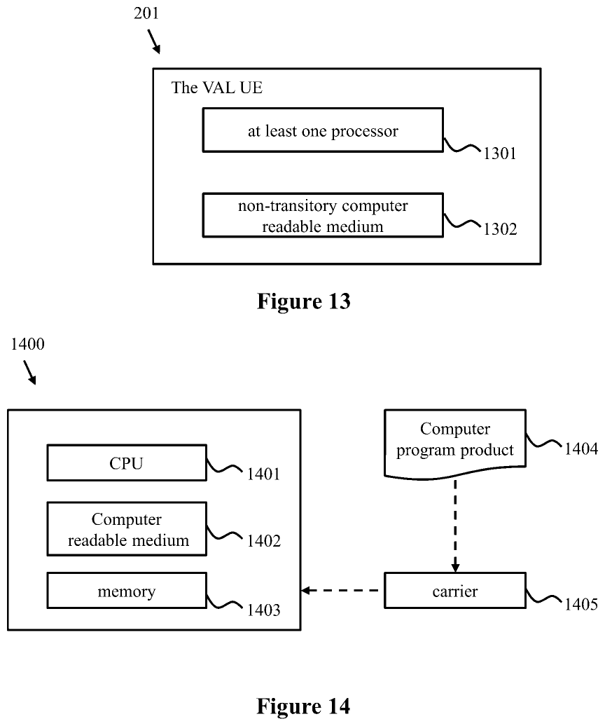

FIG. 13 is a schematic block diagram showing an example UE 201, according to the embodiments herein. In an embodiment, the example UE 201 in FIG. 13 may be implemented as including the SEALDD client 222 and the VAL client 121 in FIGS. 1-6B, FIG. 15, and FIG. 16.

In an embodiment, the UE 201 may include at least one processor 1301; and a non-transitory computer readable medium 1302 coupled to the at least one processor 1301. The non-transitory computer readable medium 1302 may store instructions executable by the at least one processor 1301, whereby the at least one processor 1301 is configured to perform the steps in the example methods 800, 900, 1100 as shown in the schematic flow charts of FIGS. 8, 9, 11; the details thereof are omitted here.

Note that, the UE 201 may be implemented as hardware, software, firmware and any combination thereof. For example, the UE 201 may include a plurality of units, circuities, modules or the like, each of which may be used to perform one or more steps of the example methods 800, 900, 1100 or one or more steps shown in FIGS. 1-6B, FIG. 15, and FIG. 16 related to the UE 201 (including the SEALDD client 222 and the VAL client 121).

FIG. 14 is a schematic block diagram showing an example computer-implemented apparatus 1400, according to the embodiments herein. In an embodiment, the apparatus 1400 may be configured as the above mentioned apparatus, such as the UE 101 or its functional component (such as the VAL client(s) 121 and/or the SEAL client(s) 122), the UE 201 or its functional component (such as the VAL client(s) 121 and/or the SEALDD client(s) 222), the first network function (such as the VAL server(s) 111), or the second network function (such as the SEALDD server 212).

In an embodiment, the apparatus 1400 may include but not limited to at least one processor such as Central Processing Unit (CPU) 1401, a computer-readable medium 1402, and a memory 1403. The memory 1403 may comprise a volatile (e.g., Random Access Memory, RAM) and/or non-volatile memory (e.g., a hard disk or flash memory). In an embodiment, the computer-readable medium 1402 may be configured to store a computer program and/or instructions, which, when executed by the processor 1401, causes the processor 1401 to carry out any of the above mentioned methods.

In an embodiment, the computer-readable medium 1402 (such as non-transitory computer readable medium) may be stored in the memory 1403. In another embodiment, the computer program may be stored in a remote location for example computer program product 1404 (also may be embodied as computer-readable medium), and accessible by the processor 1401 via for example carrier 1405.

The computer-readable medium 1402 and/or the computer program product 1404 may be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25, Internet, Local Area Network (LAN), or similar networks capable of transporting data packets to the infrastructure node).

Furthermore, the following amendments are proposed to amend the current 3GPP TS 23.433 v1.2.0.
Title: Complete transmission quality measurement

### Introduction

This pCR corrects and completes the SEALDD data transmission quality measurement procedures.

### Reason for Change

The SEALDD data transmission quality measurement procedure is not complete.

Currently, step 1 of clause 9.7.2.3 mentions that the SEALDD measurement information are configured at the SEALDD client. This configuration is not supported yet.

1.A VAL client and server establish a SEALDD connection to transport the application data. As part of the connection establishment, the SEALDD service policy in precondition 1 is shared so that it is available to both the SEALDD client and the SEALDD Server. The SEALDD Server may use the data transmission quality requirements of this policy in conjunction with other local policies pre-provisioned at the SEALDD server. As a result, SEALDD measurements (e.g. packet loss rate, latency) are configured at the SEALDD client as described in clause 9.7.2.1 and the SEALDD client receives measurement reports.

The proposed handling in this paper has the SEALDD client or server started data transmission quality measurement.

### Proposed Changes

***1st Change*** (the proposed change includes the following new sections to be added to the 3GPP TS 23.433)
9.7.2.x Data transmission quality measurement reported by SEALDD client

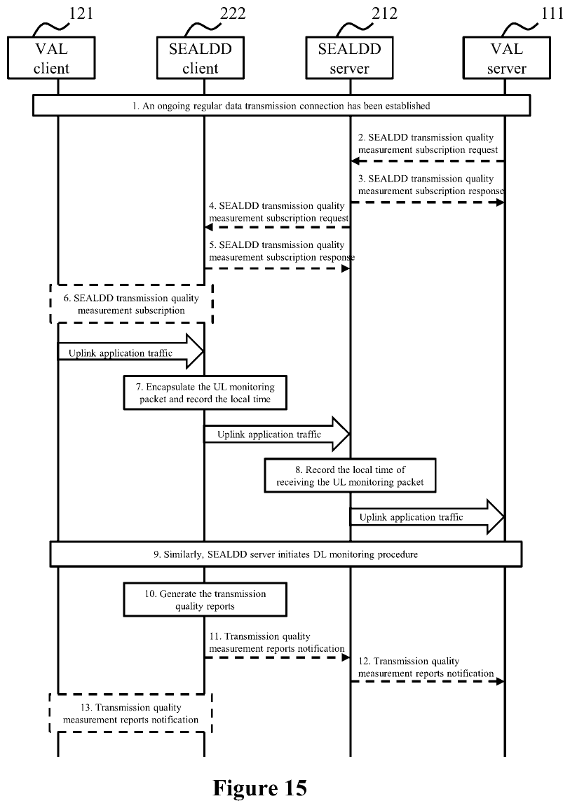

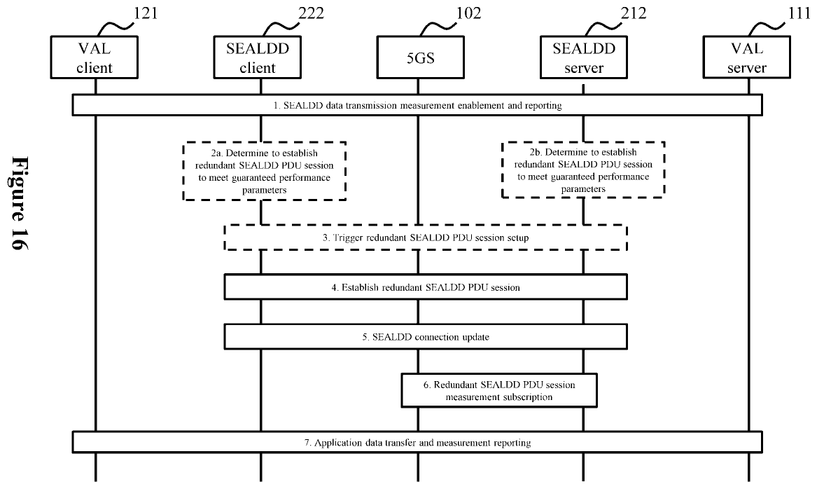

FIG. 9.7.2.x-1 (referring to FIG. 15) illustrates the procedure for SEALDD enabled data transmission quality measurement for VAL traffic. The SEALDD client receives transmission quality measurement requirement, decides to start VAL data transmission monitoring and generates measurement reports.
FIG. 9.7.2.x-1 (referring to FIG. 15): VAL data transmission quality measurement reported by SEALDD client

1.An on-going regular data transmission connection is established according to clause 9.2.2.2.

The transmission quality measurement can be triggered by VAL server or VAL client, which is described in step 2 to step 5 and step 6, correspondingly.

2. The VAL server sends a SEALDD transmission quality measurement subscription request to the SEALDD server. The request includes the identifiers of the application traffic (e.g. VAL service ID, VAL server ID), requirement of transmission quality measurement (e.g. latency, jitter, bitrate) and measurement target UE (e.g. a single UE, a group of UEs or all UEs), and may also include reporting criteria, reporting frequency, spatial condition and temporal condition.

NOTE: The spatial and/or temporal condition can be used by SEALDD client to apply when and where the measurement is performed. For instance, the measurement is expected to be done for a group of VAL UEs with a scheduled route (from city A to city B via highway A2 and A3), from 9:00 a.m. to 11:00 a.m. on Tuesday and from 1:00 p.m. to 5:00 p.m. on Thursday.

3. Upon receiving the request, the SEALDD server performs an authorization check. If authorization is successful, the SEALDD server responds to the VAL server.

4-5. The SEALDD server sends a SEALDD transmission quality measurement subscription request to the SEALDD client and the SEALDD client responds to the SEALDD server. The SEALDD client, based on the received service quality guarantee policy including thresholds and action, can take corrective action as described in clause 9.7.2.3.

6. The VAL client triggers the SEALDD transmission quality measurement procedure to the SEALDD client, in order to collect the measurement report information.

7. After SEALDD client determines to start measurement process, upon UL packet arrival, the SEALDD client initiates the UL packet delay measurement. The SEALDD client encapsulates the UL monitoring packet (i.e. UL SEALDD packet with SEALDD UL monitoring header and VAL traffic as payload for VAL data transmission quality monitoring) with local time T1 when the SEALDD client sends out the UL monitoring packet. The SEALDD client considers the spatial and/or temporal conditions when starting/resuming the transmission quality measurement. If the conditions are not satisfied, the SEALDD client stops/suspends the transmission quality measurement.

8. The SEALDD server receives the UL monitoring packet, and records the local time T2.

9. Similarly, the SEALDD server encapsulates the DL monitoring packet (i.e. DL SEALDD packet with SEALDD DL monitoring header and VAL traffic as payload, or dummy UL SEALDD packet generated for data transmission quality monitoring in case there is no DL VAL traffic for DL packet delay monitoring) with local time T2 recorded in step 8 and local time T3 when the SEALDD server sends out the DL monitoring packet.

NOTE: When the SEALDD server sends the dummy UL packet as monitoring response to the SEALDD client depends on SEALDD server implementation.

10. The SEALDD client records the local time T4 when the SEALDD client receives the DL monitoring packet and calculates the latency with T1, T2, T3, T4. The SEALDD client can also calculate the bitrate and jitter over a certain period over a specific SEALDD connection by recording the status of the SEALDD monitoring packets. The SEALDD client also evaluates the reporting criteria if present in the SEALDD transmission quality measurement subscription request in order to generate the transmission quality measurement report.

Depending on which entity triggers the data transmission quality measurement, step 11 and step 12 corresponds to step 2 to step 5, step 13 corresponds to step 6.

11-12. The SEALDD client reports the data transmission quality measurement results (e.g. latency, jitter, bitrate) to the VAL server via the SEALDD server.

13. The SEALDD client reports the data transmission quality measurement results to the VAL client.

When a VAL group ID or a list of VAL UE IDs or all VAL UEs indication is received in step 2, step 4 to step 11 is repeated for VAL UEs in the group/list or for all VAL UEs. The SEALDD server maps the VAL UE group ID to a list of VAL UE IDs if a VAL group ID is received. The SEALDD server identifies SEALDD connections corresponding to the desired VAL UE(s) to trigger measurement. And depending on the reporting requirement for multiple UEs, the SEALDD server collects and aggregates the needed report for the VAL server.
9.7.3.x1 Transmission quality measurement subscription request

Table 9.7.3.x1-1 describes the information flow from the SEALDD server to the SEALDD client for data transmission measurement subscription.

TABLE 9.7.3.x1-1
Transmission quality measurement subscription request

| Information element | Status | Description |
|---|---|---|
| SEALDD flow ID | M | Identifier of the SEALDD flow. |
| Measurement conditions | O | Indicates the temporal and/or spatial conditions. |
| Transmission quality | M | The measurement requirement information |
| measurement requirements list | | |
| > Measurement ID | M | Measurement identifiers, e.g. latency, bitrate, jitter |
| > Reporting frequency | O | The reporting frequency of measurement results |
| | | (e.g. periodic reporting). If not present, it implies |
| | | periodic reporting. |
| > Reporting periodicity | O | If the reporting frequency is periodic, the reporting |
| | | periodicity shall be provided. |
| > Measurement period window | O | Indicates the measurement period window for |
| | | transmission quality measurements |
| > Measurement expiration time | O | Indicates the measurement expiration time |
| > Reporting criteria | O | Indicates the criteria for reporting measurement |
| | | results, e.g. if the latency or bitrate reaches below |
| | | or above a certain value. It also includes a unique |
| | | identifier for each criteria of more than one criteria |
| | | is specified. |
| > Service policy | O | Specifies quality guarantee policies associated with |
| | | the SEALDD connection |
| >> Quality guarantee event | M | Indicates the event (e.g. measurement threshold) |
| | | that triggers performing the quality guarantee |
| | | action. |
| >> Quality guarantee action | M | Indicates the action to be performed when the |
| | | measurement event occurs, in order to meet the |
| | | quality guarantee. |

9.7.3.x2 Transmission quality measurement subscription response

Table 9.7.3.x2-1 describes the information flow from the SEALDD client to the SEALDD server for responding to the transmission quality measurement subscription request.

TABLE 9.7.3.x2-1
Transmission quality measurement subscription
response

| Information element | Status | Description |
|---|---|---|
| Result | M | Success or failure. |
| Expiration time | O | Indicates the expiration |
| | | time of the subscription. |
| | | Applicable for successful |
| | | result. |

9.7.3.x3 Transmission quality measurement notification

Table 9.7.3.3-1 describes the information flow from the SEALDD client to the SEALDD server for notifying the transmission quality measurement reports.

TABLE 9.7.3.x3-1
Transmission quality measurement notification

| Information element | Status | Description |
|---|---|---|
| Transmission quality | M | The generated transmission quality results in |
| measurement reports list | | SEALDD server |
| > Measurement ID | M | Measurement identifiers, e.g. latency, bitrate, jitter |
| > Average measurement value | O | The average measurement value of measurement |
| | | results |
| > Minimum measurement value | O | The minimum measurement value of measurement |
| | | results |
| > maximum measurement value | O | The maximum measurement value of |
| | | measurement results |
| > Standard deviation | O | Standard deviation measurement value of |
| measurement value | | measurement results |
| > kPercentile measurement | O | Indicates the kpercentile measurement value of |
| value | | measurement results |
| > Measurement period | O | Indicates the measurement period |
| > Timestamp | O | Indicates the timestamp of measurement results |

***2nd Change*** (the proposed change includes the content to be replace the current section 9.7.2.3)
9.7.2.3 SEALDD enabled data transmission quality guarantee with redundant transport

FIG. 9.7.2.3-1 (referring to FIG. 16) illustrates the procedure of using redundant transmission as the action to meet connection reliability requirements specified by a SEALDD service policy.

### Pre-Conditions:

1.A SEALDD service policy, which includes data transmission quality guarantees, is available to SEALDD server, SEALDD client and/or VAL client. The policy can be used to configure measurements and determine the necessary SEALDD layer actions for meeting the service policy requirements.

2. The SEALDD Client is authorized to request redundant transport services on behalf of the VAL client.
FIG. 9.7.2.3-1 (referring to FIG. 16): SEALDD data transmission quality guarantee with redundant transmission

1.A VAL client and server establish a SEALDD connection to transport the application data. As part of the connection establishment, the SEALDD service policy in precondition 1 is shared so that it is available to both the SEALDD client and the SEALDD Server. The SEALDD Server may use the data transmission quality requirements of this policy in conjunction with other local policies pre-provisioned at the SEALDD server. The SEALDD service policy can be locally configured at the SEALDD Server or provided by the VAL server and accepted/authorized by SEALDD Server. The SEALDD server determines whether to start data transmission quality measurement by itself or by the SEALDD client. As a result, SEALDD measurements (e.g. packet loss rate, latency) are configured either at the SEALDD client as described in clause 9.7.2.x or at the SEALDD server as described in clause 9.7.2.1 and started accordingly. Then either the SEALDD server or client receives measurement reports.

2. Based on measurement reports and the SEALDD service policy, depending on the which entity started the measurement, either the SEALDD client or server determines to perform an action so that the data transmission quality requirements of the policy are met.

3. Specifically, if the measurement was started by the SEALDD client, the SEALDD client triggers the establishment of redundant transmission services. If the measurement was started by the SEALDD server, the SEALDD server triggers the establishment of redundant transmission services by sending a Transmission quality guarantee request to the SEALDD client requesting to establish redundant transmission path.

NOTE: The request can be sent to SEALDD client via Application Triggering (specified in clause 4.13.2 of 3GPP TS 23.502 [6]) with payload indicating a trigger of a redundant connection setup for SEALDD packet transmission.

4. The SEALDD client uses steps 6 to 9 of the procedure in clause 9.3.2.1 to request the use of redundant transmission service from the SEALDD server. As part of this step, the UE may end the initial PDU session and establish redundant PDU sessions.

5. The SEALDD client updates the SEALDD connection with the redundant transmission information, i.e., the UE addresses and ports for the redundant PDU sessions, the SEALDD flow identifier, and the application traffic descriptors. The SEALDD client or server also configures the parameters for enabling any necessary SEALDD measurements for the new SEALDD flow.

6. The SEALDD server may subscribe to receive notifications from the 5G network for user plane measurements (e.g., the network latency requirements specified in 3GPP TS 28.541 [12]), network analytics (as specified in 3GPP TS 28.104 [11], etc.).

7. The SEALDD client and server handle data duplication and elimination of application traffic on the redundant SEALDD flows and the necessary measurements are collected by the SEALDD client or server.

When the SEALDD measurement results indicating that the SEALDD data transmission has good performance according to policy guarantee threshold, if the measurement was started by the SEALDD client, the SEALDD client may release one transmission path and return back to single SEALDD connection mode, otherwise the SEALDD server may send a request to the SEALDD client requesting to use single transmission, then the SEALDD client releases one transmission path and returns to single SEALDD connection mode.
***3rd Change*** (the proposed change includes the following new sections to be added to the 3GPP TS 23.433)
9.7.3.x4 Transmission quality guarantee request

Table 9.7.3.x4-1 describes the information flow from the SEALDD server to the SEALDD client for requesting data transmission quality guarantee.

TABLE 9.7.3.x4-1
Transmission quality guarantee request

| Information element | Status | Description |
|---|---|---|
| SEALDD flow ID | M | Identifier of the SEALDD flow. |
| Transmission quality | M | Indicates the data transmission |
| guarantee action | | quality guarantee action (e.g. |
| | | redundant transmission path, |
| | | re-establish transmission path). |

9.7.3.x5 Transmission quality guarantee response

Table 9.7.3.x5-1 describes the information flow from the SEALDD client to the SEALDD server for responding to the transmission quality guarantee request.

TABLE 9.7.3.x5-1
Transmission quality guarantee response

| Information element | Status | Description |
|---|---|---|
| Result | M | Success or failure. |

***End of Changes***

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, may be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that may direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

### Abbreviations

3GPP 3rd Generation Partnership Project
API Application Programming Interface
DD Data Delivery
DL Downlink
OTT Over The Top
QoS Quality of Service
SEAL Service Enablement Architecture Layer for Verticals
SEALDD SEAL Data Delivery
UE User Equipment
UP Uplink
V2X vehicle to everything
VAL Vertical Application Layer.

1.-53. (canceled)

54. A method performed by a computer-implemented apparatus that is configured as a first network function implementing a Service Enabler Architecture Layer (SEAL) Data Delivery (DD) server, the method comprising:
transmitting, to a Vertical Application Layer (VAL) User Equipment (UE), a subscription message for requesting reporting of a transmission quality measurement for VAL UE traffic, wherein the VAL UE includes a first functional component implementing a SEALDD client; and
receiving, from the VAL UE, a notification message for providing reporting of a plurality of measurement results of the transmission quality measurement.

55. The method according to claim 54, wherein the subscription message includes:
a first parameter indicating at least one VAL application traffic to be measured; and
a second parameter indicating measurement requirement information.

56. The method according to claim 55, wherein the subscription message further includes a third parameter indicating one or more measurement conditions for the transmission quality measurement.

57. The method according to claim 56, wherein:
the one or more measurement conditions include one or more spatial conditions and/or one or more temporal conditions; and/or
if the one or more conditions are not satisfied, the first functional component implementing the SEALDD client is to stop or suspend the transmission quality measurement.

58. A method performed by a Vertical Application Layer (VAL) User Equipment (UE) including a first functional component implementing a Service Enabler Architecture Layer (SEAL) Data Delivery (DD) client, the method comprising:
receiving, from a network function implementing a SEALDD server or a second functional component within the VAL UE implementing a VAL client, a subscription message for requesting reporting of a transmission quality measurement for VAL UE traffic; and
transmitting a notification message for providing reporting of a plurality of measurement results of the transmission quality measurement.

59. The method according to claim 58, wherein the subscription message includes:
a first parameter indicating at least one VAL application traffic to be measured; and
a second parameter indicating measurement requirement information.

60. The method according to claim 59, wherein the subscription message further includes a third parameter indicating one or more measurement conditions for the transmission quality measurement.

61. The method according to claim 60, wherein:
the one or more measurement conditions include one or more spatial conditions and/or one or more temporal conditions; and/or
if the one or more conditions are not satisfied, the first functional component implementing the SEALDD client stops or suspends the transmission quality measurement.

62. The method according to claim 59, wherein the measurement requirement information includes a fourth parameter indicating a measurement on any one or combination of latency, bitrate, or packet loss rate.

63. The method according to claim 62, wherein the measurement requirement information further includes at least one of the following:
a fifth parameter indicating whether the reporting is set to a periodic reporting;
a sixth parameter indicating a reporting periodicity if the reporting is set to a periodic reporting;
a seventh parameter indicating a measurement period window for the transmission quality measurement;
an eighth parameter indicating a measurement expiration time for the transmission quality measurement;
a ninth parameter indicating reporting criteria for reporting a measurement result of the transmission quality measurement; and
a tenth parameter indicating a service quality guarantee policy associated with the SEALDD flow.

64. The method according to claim 63, wherein the reporting criteria includes:
reporting a measurement result of the transmission quality measurement if a latency or bitrate is higher or lower than a value; and/or
a unique identifier for each criteria of a plurality of criteria predefined.

65. The method according to claim 63, wherein the service quality guarantee policy includes:
an eleventh parameter indicating an event triggering a quality guarantee action; and
a twelfth parameter indicating the quality guarantee action to be performed when the event occurs.

66. The method according to claim 65, wherein the event includes that a measurement threshold is reached.

67. The method according to claim 66, further comprising:
determining to start a measurement process;
initiating uplink packet delay measurement; and
obtaining the plurality of measurement results.

68. The method according to claim 58, wherein the notification message includes a thirteenth parameter indicating a generated transmission quality measurement report list for the transmission quality measurement.

69. The method according to claim 68, wherein the transmission quality measurement reports list further includes a fourteenth parameter indicating a measurement on any one or combination of latency, bitrate, or packet loss rate based on the fourth parameter.

70. The method according to claim 69, wherein the transmission quality measurement report list further includes at least one of the following:
a fifteenth parameter indicating an average measurement value of the plurality of measurement results;
a sixteenth parameter indicating a minimum measurement value of the plurality of measurement results;
a seventeenth parameter indicating a maximum measurement value of the plurality of measurement results;
an eighteenth parameter indicating a standard deviation measurement value of the plurality of measurement results;
a nineteenth parameter indicating a kpercentile measurement value of the plurality of measurement results;
a twentieth parameter indicating a measurement period for the plurality of measurement results based on the seventh parameter; and
a twenty-first parameter indicating a timestamp of the plurality of measurement results.

71. The method according to claim 58, further comprising transmitting a response message for responding to the subscription message, wherein the response message includes a twenty-second parameter indicating whether a subscription requested by the subscription message succeeded or failed.

72. The method according to claim 71, wherein the response message further includes a twenty-third parameter indicating an expiration time of the subscription, if the twenty-second parameter indicates that the subscription succeeded.

73. The method according to claim 58, wherein:
the subscription message is a transmission quality measurement subscription request;
the notification message is a transmission quality measurement notification transmitted to the network function implementing the SEALDD server or the second functional component implementing the VAL client; and/or
the response message is a transmission quality measurement subscription response transmitted to the network function implementing the SEALDD server or the second functional component implementing the VAL client.

74. A Vertical Application Layer (VAL) User Equipment (UE), comprising:
at least one processor; and
a non-transitory computer readable medium coupled to the at least one processor, the non-transitory computer readable medium containing instructions executable by the at least one processor, whereby the at least one processor is configured to:
receive, from a network function implementing a Service Enabler Architecture Layer (SEAL) Data Delivery (DD) server or a second functional component within the VAL UE implementing a VAL client, a subscription message for requesting reporting of a transmission quality measurement for VAL UE traffic; and
transmit a notification message for providing reporting of a plurality of measurement results of the transmission quality measurement.
